(19) United States
(12) Patent Application Publication
(10) Pub. No.: US 2020/0332159 A1
(43) Pub. Date: Oct. 22, 2020

(54) FRAME SEALANT, PREPARATION METHOD THEREFOR, AND DISPLAY MOTHER SUBSTRATE AND DISPLAY DEVICE USING SAME

(71) Applicants: BEIJING BOE OPTOELECTRONICS TECHNOLOGY CO., LTD., Beijing (CN); BOE TECHNOLOGY GROUP CO., LTD., Beijing (CN)

(72) Inventors: Hongpeng LI, Beijing (CN); Juan DU, Beijing (CN)

(73) Assignees: BEIJING BOE OPTOELECTRONICS TECHNOLOGY CO., LTD., Beijing (CN); BOE TECHNOLOGY GROUP CO., LTD., Beijing (CN)

(21) Appl. No.: 16/097,671

(22) PCT Filed: Feb. 6, 2018
(86) PCT No.: PCT/CN2018/075436

§ 371 Date: Oct. 30, 2018

(30) Foreign Application Priority Data
Mar. 8, 2017 (CN) 201710134631.6

(51) Int. Cl. C09J 133/08; C09J 4/06; C09J 11/06; G02F 1/1339

(52) U.S. Cl. CPC C09J 133/08; G02F 1/1339; C09J 11/06; C09J 4/06

(57) ABSTRACT

The present disclosure relates to a frame sealant, a preparation method therefor, and a display mother substrate and a display device using the same. The sealant includes: 20-30 parts by weight of a long-chain acrylate emulsion, 4-8 parts by weight of a photoinitiator, 10-20 parts by weight of a methacrylate, and 46-66 parts by weight of fibers.

The present application claims the priority of the Chinese Patent Application No. 201710134631.6 filed on Mar. 8, 2017, which is incorporated herein by reference as part of the disclosure of the present application.

### TECHNICAL FIELD

Embodiments of the present disclosure relate to a frame sealant, a manufacturing method of the frame sealant, and a display motherboard and a display device using the frame sealant.

### BACKGROUND

As an important human-device interaction carrier, liquid crystal display panels with a touch function have attracted more and more attention, which are mainly formed by a full fit technology. The full fit technology mainly comprises an in-cell technology, an on-cell technology and an OGS (one glass solution) technology. The on-cell technology has attracted more attention due to its low production cost and simple operation process.

The on-cell technology is a method of embedding a touch screen between a color filter and a polarizer of a display screen, that is, manufacturing a touch sensor on the liquid crystal display panel. For example, the manufacturing method comprises: putting a liquid crystal display panel that has been cut or not been cut in a vacuum environment after being thinned, and depositing a layer of ITO (Indium Tin Oxide) film on the liquid crystal display panel. The ITO film acts as a touch sensor and the ITO film is deposited in a vacuum environment at a temperature of 90° C.

### SUMMARY

Embodiments of the present disclosure relate to a frame sealant, a manufacturing method of the frame sealant, a display mother substrate and a display device, and the frame sealant can solve the problem of panel bursting.

At least one embodiment of the present disclosure provides a frame sealant which comprises: about 20 to 30 parts by weight of a long-chain acrylate emulsion, about 4 to 8 parts by weight of a photoinitiator, about 10 to 20 parts by weight of a methacrylate, and about 46 to 66 parts by weight of a fiber.

For example, the frame sealant provided by at least one embodiment of the present disclosure comprises: about 22 to 28 parts by weight of the long-chain acrylate emulsion, about 5 to 7 parts by weight of the photoinitiator, about 12 to 18 parts by weight of the methacrylate, and about 48 to 60 parts by weight of the fiber.

For example, the frame sealant provided by at least one embodiment of the present disclosure comprises: about 25 parts by weight of the long-chain acrylate emulsion, about 6 parts by weight of the photoinitiator, about 15 parts by weight of the methacrylate, and about 54 parts by weight of the fiber.

For example, in the frame sealant provided by at least one embodiment of the present disclosure, the fiber comprises at least one of a natural fiber, a glass fiber, a carbon fiber, a boron fiber, a metal fiber and a ceramic fiber.

For example, in the frame sealant provided by at least one embodiment of the present disclosure, the natural fiber comprises at least one of a cotton fiber and a hemp fiber.

For example, in the frame sealant provided by at least one embodiment of the present disclosure, the long-chain acrylate emulsion is a mixture formed by a long-chain acrylate, an emulsifier and deionized water.

For example, in the frame sealant provided by at least one embodiment of the present disclosure, a weight ratio of the long-chain acrylate, the emulsifier and the deionized water is about (41 to 46):about (8 to 18):about (41 to 46).

For example, in the frame sealant provided by at least one embodiment of the present disclosure, the weight ratio of the long-chain acrylate, the emulsifier and the deionized water is about (42 to 45):about (11 to 16):about (42 to 45).

For example, in the frame sealant provided by at least one embodiment of the present disclosure, the weight ratio of the long-chain acrylate, the emulsifier and the deionized water is about 44:12:44.

For example, in the frame sealant provided by at least one embodiment of the present disclosure, the long-chain acrylate comprises at least one of octadecyl acrylate, hexadecyl methacrylate, tetradecyl methacrylate, and urethane dimethacrylate.

For example, in the frame sealant provided by at least one embodiment of the present disclosure, the emulsifier comprises at least one of fatty alcohol polyoxyethylene ether (N=3), fatty alcohol polyoxyethylene ether (N=9) and fatty alcohol polyoxyethylene ether (N=10).

For example, in the frame sealant provided by at least one embodiment of the present disclosure, the photoinitiator comprises at least one of α, α-diethoxyacetophenone, α-hydroxyalkylphenone and α-amino alkyl phenone.

At least one embodiment of the present disclosure further provides a manufacturing method of the frame sealant, and the manufacturing method comprises: forming the long-chain acrylate emulsion; and mixing and milling about 20 to 30 parts by weight of the long-chain acrylate emulsion, about 4 to 8 parts by weight of the photoinitiator, about 10 to 20 parts by weight of the methacrylate, and about 46 to 66 parts by weight of the fiber to obtain the frame sealant.

For example, in the manufacturing method provided by at least one embodiment of the present disclosure, the forming the long-chain acrylate emulsion comprises: placing a long-chain acrylate and an emulsifier in a reactor to form a mixture, stirring the mixture at a temperature of about 30° C. to about 45° C., adding deionized water to the mixture, and stirring the mixture again.

For example, in the manufacturing method provided by at least one embodiment of the present disclosure, a weight ratio of the long-chain acrylate, the emulsifier and the deionized water is about (41 to 46):about (8 to 18):about (41 to 46).

For example, in the manufacturing method provided by at least one embodiment of the present disclosure, the weight ratio of the long-chain acrylate, the emulsifier and the deionized water is about (42 to 45):about (11 to 16):about (42 to 45).

For example, in the manufacturing method provided by at least one embodiment of the present disclosure, the weight ratio of the long-chain acrylate, the emulsifier and the deionized water is about 44:12:44.

At least one embodiment of the present disclosure further provides a display mother substrate, and the display mother substrate comprises any one of the above-mentioned frame sealants.

At least one embodiment of the present disclosure further provides a display device, and the display device comprises a display panel in any of the display mother substrates described above.

### BRIEF DESCRIPTION OF THE DRAWINGS

In order to clearly illustrate the technical solution of the embodiments of the present disclosure, the drawings of the embodiments will be briefly described. It is apparent that the described drawings are only related to some embodiments of the present disclosure and thus are not limitative of the present disclosure.

FIG. 1 is a schematic diagram of a planar structure of a display mother substrate;

FIG. 2A is a scanning electron microscope (SEM) of a frame sealant after being cured according to an embodiment of the present disclosure;

FIG. 2B is a local enlarged diagram of FIG. 2A; and

FIG. 3 is a schematic diagram of a planar structure of the display mother substrate provided by an embodiment of the present disclosure.

### REFERENCE NUMERALS

1—fiber; 2—main frame sealant; 3—opening position of peripheral frame sealant; 4—peripheral frame sealant.

### DETAILED DESCRIPTION

In order to make objects, technical details and advantages of embodiments of the present disclosure clear, the technical solutions of the embodiments of the present disclosure will be described in a clearly and fully understandable way in connection with the related drawings. It is apparent that the described embodiments are just a part but not all of the embodiments of the present disclosure. Based on the described embodiments herein, one of ordinary skill in the art can obtain, without any inventive work, other embodiment(s) which should be within the scope of the present disclosure.

Unless otherwise defined, all the technical and scientific terms used herein shall have the same meanings as commonly understood by one of ordinary skill in the art to which the present invention belongs. The terms “first,” “second,” etc., which are used in the description and claims of the present application, are not intended to indicate any sequence, amount or importance, but to distinguish various components. The terms “comprises,” “comprising,” “includes,” “including,” etc., are intended to specify that the elements or the objects stated before these terms encompass the elements or the objects listed after these terms as well as equivalents thereof, but do not exclude other elements or objects. The terms “on,” “under,” “right,” “left” and the like are only used to indicate relative position relationship, and in the case that the position of an object is described as being changed, the relative position relationship may be changed accordingly.

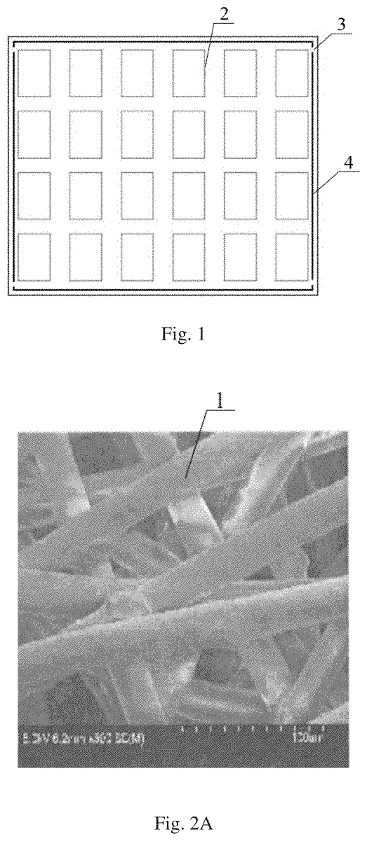

FIG. 1 is a schematic diagram of a planar structure of a display mother substrate. As illustrated in FIG. 1, the display mother substrate comprises a plurality of display panels spaced apart from each other. Peripheral regions of each display panel are provided with main frame sealants 2. The display mother substrate further includes a peripheral frame sealant 4 having opening positions 3. In the process of manufacturing a liquid crystal display mother substrate, the peripheral frame sealant is generally manufactured by an opening process to balance a pressure difference between an inside and an outside of the main frame sealants in the liquid crystal display mother substrate, and to prevent the occurrence of undesirable phenomena such as liquid leakage in an ODF (one drop filling) process. Furthermore, in the subsequent thinning process, in order to prevent acidic liquids from entering each display panel, it is necessary to apply a frame sealant at the opening position 3 and solidify the frame sealant. In this way, air is sealed inside the display mother substrate, i.e., a Q-panel. In the subsequent process of vacuum coating, the base substrate is prone to burst from inside to outside due to a pressure difference between the inside and the outside of the Q-panel.

If a dummy seal close process is used directly, the bursting of the display panel will be more serious.

The frame sealant provided by at least one embodiment of the present disclosure comprises: about 20 to 30 parts by weight of a long-chain acrylate emulsion, about 4 to 8 parts by weight of a photoinitiator, about 10 to 20 parts by weight of a methacrylate, and about 46 to 66 parts by weight of a fiber. In at least one embodiment of the present disclosure, the frame sealant comprises a combination of the fiber and long-chain acrylate, wherein a content of the fiber is high and a content of the methacrylate is low. In this way, after curing the frame sealant, pores of micrometer size are formed. These pores can form channels for gas molecules, and thus the frame sealant has air permeability and hydrophobicity.

In the embodiment of the present disclosure, the fiber has been sufficiently soaked by a hydrophobic long-chain acrylate emulsion. In order to make each of the display panels formed lighter and thinner, the display mother substrate needs to be thinned In the process of thinning the display mother substrate, the entry of acidic liquid is prevented, and it is unnecessary to apply a frame sealant at the opening position of the peripheral frame sealant and solidify the frame sealant. Moreover, the frame sealant provided by the embodiment of the present disclosure has air permeability, and even if air is sealed inside the Q-panel, the air inside the Q-panel can gradually disappear in a vacuum environment. Thus, the bursting caused by the air pressure inside the Q-panel in an opening process is avoided by preventing the acidic liquid from entering and allowing the air inside the Q-panel to dissipate.

The frame sealant provided by the embodiment of the present disclosure has air permeability and hydrophobicity. In a case that the frame sealant provided by the embodiment of the present disclosure is used as the peripheral frame sealant, the sealing process before solidification of the main frame sealant can also avoid liquid leakage caused by the bursting of the panel.

It should be noted that the “long-chain acrylate” in the present disclosure refers to acrylate with a total number of carbon atoms of more than 12.

For example, in an embodiment of the present disclosure, the curing methods of the peripheral frame sealant and the main frame sealant are as follows: firstly, ultraviolet light (UV) irradiation is carried out with an integrated light intensity of 7000 mJ/cm² to 10000 mJ/cm², and then heating is performed at 120° C. for 1 h.

For example, the frame sealant provided by an embodiment of the present disclosure comprises: about 20 to 30 parts by weight of a long-chain acrylate emulsion, about 4 to 8 parts by weight of a photoinitiator, about 10 to 20 parts by weight of a methacrylate, and about 46 to 66 parts by weight of a fiber.

For a further example, the frame sealant comprises: about 22 to 28 parts by weight of the long-chain acrylate emulsion, about 5 to 7 parts by weight of the photoinitiator, about 12 to 18 parts by weight of the methacrylate, and about 48 to 60 parts by weight of the fiber.

For another further example, the frame sealant comprises: about 25 parts by weight of the long-chain acrylate emulsion, about 6 parts by weight of the photoinitiator, about 15 parts by weight of the methacrylate, and about 54 parts by weight of the fiber.

For example, the fiber comprises at least one of a natural fiber, a glass fiber, a carbon fiber, a boron fiber, a metal fiber and a ceramic fiber.

For example, the natural fiber comprises a plant fiber, and the plant fiber comprises at least one of a cotton fiber and a hemp fiber.

For example, the long-chain acrylate emulsion is a mixture formed by a long-chain acrylate, an emulsifier and deionized water.

For example, the long-chain acrylate emulsion is obtained by mixing the long-chain acrylate and the emulsifier to form a mixture and then mixing the mixture with the deionized water, wherein a weight ratio of the long-chain acrylate to the emulsifier in the mixture is about (70 to 85):about (15 to 30), and a weight ratio of the mixture to the deionized water is about (45 to 55):about (45 to 55).

For example, a weight ratio of the long-chain acrylate, the emulsifier and the deionized water is about (41 to 46):about (8 to 18):about (41 to 46).

For a further example, the weight ratio of the long-chain acrylate, the emulsifier and the deionized water is about (42 to 45):about (11 to 16):about (42 to 45).

For a further example, the weight ratio of the long-chain acrylate, the emulsifier and the deionized water is about 44:12:44.

For example, in the frame sealant provided by at least one embodiment of the present disclosure, the long-chain acrylate comprises at least one of octadecyl acrylate, hexadecyl methacrylate, tetradecyl methacrylate and urethane dimethacrylate. Generally, the long-chain acrylate is commercially available, and the purity of the long-chain acrylate is industrial grade.

For example, the emulsifier comprises at least one of fatty alcohol polyoxyethylene ether (N=3), fatty alcohol polyoxyethylene ether (N=9) and fatty alcohol polyoxyethylene ether (N=10) (that is, O3, O9, O10). Further, the emulsifier comprises any two or three of the fatty alcohol polyoxyethylene ether (N=3), the fatty alcohol polyoxyethylene ether (N=9) and the fatty alcohol polyoxyethylene ether (N=10).

In general, the emulsifying effect of an emulsifier combination is better than that of a single emulsifier. Therefore, a mixture of the long-chain acrylate and the emulsifier is used to improve the hydrophobicity and air-permeability of the frame sealant.

It should be noted that, the fatty alcohol polyoxyethylene ether (AEO), also known as polyoxyethylene fatty alcohol ether, is a non-ionic surfactant. The surfactant is an ether formed by condensation of polyethylene glycol (PEG) with a fatty alcohol, and is represented by the following general formula: RO(CH₂CH₂O)ₙH, wherein R is generally a saturated or an unsaturated hydrocarbon group of C12 to C18, which can be a straight chain hydrocarbon group or a branched hydrocarbon group; n is an addition number of ethylene oxide, that is, the number of oxyethylene groups in the surfactant molecule, where the greater the n, the more oxygen in the molecular hydrophilic group, the more hydrogen bonds are formed with water, the better the water solubility is. In a case that n is 1 to 5, the product is soluble in oil but insoluble in water, and is typically used as raw material for the preparation of an anionic surfactant of sulfuric acid ester. In a case that n is 6 to 8, the product is soluble in water and is commonly used as a detergent of textiles and an oil emulsifier. In a case that n is 10 to 20, the product is industrially used as an emulsifier and a leveling agent. According to the polymerization degree of polyethylene glycol and the type of fatty alcohol, the fatty alcohol polyoxyethylene ether can be used as an O/W type emulsifier.

For example, the number of carbon atoms in the fatty alcohol polyoxyethylene ether is 10 to 20, specifically, the number of carbon atoms is 15.

For example, the methacrylate as a photo-polymerizable compound, can be a monofunctional methacrylate and/or a multifunctional methacrylate.

For example, the methacrylate can be trimethylolpropane trimethacrylate, pentaerythritol trimethacrylate, glycerol trimethacrylate, tris(2-hydroxyethyl)isocyanurate trimethacrylate, ethylene glycol dimethacrylate, propanediol methacrylate, 1,3-butanediol dimethacrylate, 1,4-butanediol dimethacrylate, 1,6-hexanediol dimethacrylate, neopentylene glycol dimethacrylate, diethylene glycol dimethacrylate, triethylene glycol dimethacrylate or dipropylene glycol dimethacrylate.

For example, the photoinitiator is at least one of α,α-diethoxyacetophenone, α-hydroxyalkylphenone and α-amino alkyl phenone.

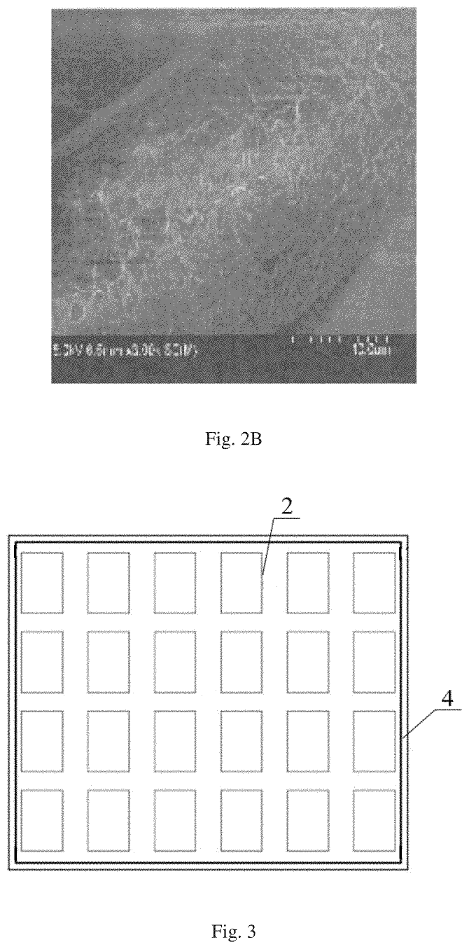

For example, FIG. 2A is a scanning electron microscope (SEM) of a frame sealant after being cured according to an embodiment of the present disclosure. FIG. 2B is a local enlarged diagram of FIG. 2A. As illustrated in FIG. 2A, there are gaps between the fibers in the frame sealant to form air channels.

At least one embodiment of the present disclosure further provides a manufacturing method of the frame sealant, and the manufacturing method comprises:

Step 1: forming the long-chain acrylate emulsion;

Step 2: mixing and milling about 20 to 30 parts by weight of the long-chain acrylate emulsion, about 4 to 8 parts by weight of the photoinitiator, about 10 to 20 parts by weight of the methacrylate, and about 46 to 66 parts by weight of the fiber to obtain the frame sealant.

For example, the forming the long-chain acrylate emulsion comprises: placing a long-chain acrylate and an emulsifier in a reactor to form a mixture, stirring the mixture at a temperature of about 30° C. to about 45° C., adding deionized water to the mixture, and stirring the mixture again.

For example, “adding deionized water to the mixture” is carried out slowly in a dripping manner, for example, the dripping rate is 8 to 10 drops per minute.

For example, “stirring” can be carried out at a constant temperature. For example, stirring can be carried out at a temperature of about 30° C., 32° C., 34° C., 35° C., 36° C., 37° C., 39° C., 40° C., 42° C., and 45° C., and the stirring duration can be about 1 h to 5 h, for example, 1 h, 1.5 h, 2 h, 3 h, 4 h and 5 h, where the stirring duration is based on the time for completely mixing the materials.

For example, the stirring method can be manual stirring or mechanical stirring, wherein the mechanical stirring can be carried out by using a concentrated thermostatic heating magnetic stirrer.

For example, “mixing and milling” can be carried out at a constant temperature of about 30° C. to 40° C. for about 1 h to 5 h, for example, the mixing and milling can be carried out at a constant temperature of 30° C. for 5 h, at a constant temperature of 33° C. for 5 h, at a constant temperature of 35° C. for 3 h, at a constant temperature of 35° C. for 2 h, at a constant temperature of 38° C. for 2 h, at a constant temperature of 40° C. for 1 h, and so on.

For example, the weight ratio of the long-chain acrylate, the emulsifier and the deionized water is about (41 to 46):about (8 to 18):about (41 to 46).

For a further example, the weight ratio of the long-chain acrylate, the emulsifier and the deionized water is about (42 to 45):about (11 to 16):about (42 to 45).

For a further example, the weight ratio of the long-chain acrylate, the emulsifier and the deionized water is about 44:12:44.

For example, the fibers need to be pulverized by a crusher and then be mixed.

For example, a mesh number of a sieve for sieving the pulverized fibers ranges from 800 meshes to 1500 meshes.

For example, the mesh number of the sieve for sieving the pulverized fibers is 800 meshes, 1000 meshes, 1200 meshes, 1300 meshes or 1500 meshes; accordingly, the aperture sizes of sieve holes corresponding to the above-mentioned mesh numbers are 18 μm, 12.5 μm, 11.5 μm, 10 μm and 2.5 μm, respectively.

It should be noted that, if the mesh number of the selected sieve is too small, the large size of the fiber would lead to uneven wetting of emulsion; if the mesh number of the selected sieve is too large, the small size of the fiber would lead to blockage in the channels.

For example, the fiber comprises at least one of natural fibers, glass fibers, carbon fibers, boron fibers, metal fibers and ceramic fibers.

For example, the natural fiber comprises a plant fiber, and the plant fiber comprises at least one of a cotton fiber and a hemp fiber.

For example, the long-chain acrylate comprises at least one of octadecyl acrylate, hexadecyl methacrylate, tetradecyl methacrylate and urethane dimethacrylate. Generally, the long-chain acrylate is commercially available, and the purity of the long-chain acrylate is industrial grade.

For example, the emulsifier comprises at least one of fatty alcohol polyoxyethylene ether (N=3), fatty alcohol polyoxyethylene ether (N=9) and fatty alcohol polyoxyethylene ether (N=10) (that is, O3, O9, O10). Further, the emulsifier comprises any two or three of the fatty alcohol polyoxyethylene ether (N=3), the fatty alcohol polyoxyethylene ether (N=9) and the fatty alcohol polyoxyethylene ether (N=10).

In general, the emulsifying effect of an emulsifier combination is better than that of a single emulsifier. Therefore, a mixture of the long-chain acrylate and the emulsifier is used to improve the hydrophobicity and air-permeability of the frame sealant.

It should be noted that, the fatty alcohol polyoxyethylene ether (AEO), also known as polyoxyethylene fatty alcohol ether, is a non-ionic surfactant. The surfactant is an ether formed by condensation of polyethylene glycol (PEG) with a fatty alcohol, and is represented by the following general formula: RO(CH₂CH₂O)ₙH, wherein R is generally a saturated or an unsaturated hydrocarbon group of C12 to C18, which can be a straight chain hydrocarbon group or a branched hydrocarbon group; n is an addition number of ethylene oxide, that is, the number of oxyethylene groups in the surfactant molecule, where the greater the n, the more oxygen in the hydrophilic group, the more hydrogen bonds are formed with water, the better the water solubility is. In a case that n is 1 to 5, the product is soluble in oil but insoluble in water, and is typically used as raw material for the preparation of an anionic surfactant of sulfuric acid ester. In a case that n is 6 to 8, the product is soluble in water, and is commonly used as a detergent of textiles and an oil emulsifier. In a case that n is 10 to 20, the product is industrially used as an emulsifier and a leveling agent. According to the polymerization degree of polyethylene glycol and the type of fatty alcohol, the fatty alcohol polyoxyethylene ether can be used as an O/W type emulsifier.

For example, the number of carbon atoms in the fatty alcohol polyoxyethylene ether is 10 to 20, specifically, the number of carbon atoms is 15. For example, the methacrylate as a photo-polymerizable compound, can be a monofunctional methacrylate and/or a multifunctional methacrylate.

For example, the methacrylate can be trimethylolpropane trimethacrylate, pentaerythritol trimethacrylate, glycerol trimethacrylate, tris(2-hydroxyethyl)isocyanurate trimethacrylate, ethylene glycol dimethacrylate, propanediol methacrylate, 1,3-butanediol dimethacrylate, 1,4-butanediol dimethacrylate, 1,6-hexanediol dimethacrylate, neopentylene glycol dimethacrylate, diethylene glycol dimethacrylate, triethylene glycol dimethacrylate or dipropylene glycol dimethacrylate.

For example, the methacrylate can be purchased from the Shanghai Chemical Reagent Factory. For example, the photoinitiator is at least one of α,α-diethoxyacetophenone, α-hydroxyalkylphenone and α-amino alkyl phenone.

At least one embodiment of the present disclosure further provides a display panel comprising any one of the frame sealants described above. For example, the frame sealant can be used as a peripheral frame sealant.

At least one embodiment of the present disclosure further provides a display mother substrate comprising any of the above-mentioned frame sealants. For example, FIG. 3 is a schematic diagram of a planar structure of the display mother substrate provided by an embodiment of the present disclosure. During forming the frame sealant, a spray nozzle with a diameter of 0.4 mm is used for spraying to avoid clogging. The display mother substrate is provided with a main frame sealant 2 and a peripheral frame sealant 4. Before the main frame sealant is solidified, the display mother substrate adopts a sealing process to avoid liquid leakage caused by the rupture of the panel.

For example, the display mother substrate provided by the embodiment of the present disclosure is prepared by the following method, comprising:

(1) coating an edge of the upper glass substrate and/or an edge of the lower glass substrate with the frame sealant according to an embodiment of the present disclosure by the spray nozzle with a diameter of 0.4 mm, wherein the frame sealant acts as the peripheral frame sealant; and placing the main frame sealant around the internal display panel; and

(2) assembling the upper glass substrate and the lower glass substrate to obtain the display mother substrate.

At least one embodiment of the present disclosure further provides a display device, comprising a display panel in any one of the display mother substrates described above. The display device, for example, is a liquid crystal display panel, a mobile phone, a tablet, a television, a monitor, a laptop, a digital photo frame, a navigator, and any other product or component with a display function.

### Example 1

(1) Cotton fibers are pulverized by a fiber crusher (Qingdao Ruixintai Machinery Technology Co., Ltd), and the pulverized cotton fibers are sieved by a sieve with 1500 meshes.

(2) A certain amount of octadecyl acrylate (Shanghai Chemical Reagent Factory) is placed in a reactor, and then O3 and O9 are added sequentially, and a mixture is obtained by stirring at a constant temperature of 35° C. for 2 h, wherein a weight ratio of the octadecyl acrylate and O3 and O9 is 85:5:10. Then, the mixture is added to a certain amount of distilled water at a rate of 9 drops per min, in which a weight ratio of the mixture to the distilled water is 50:50. Finally, the mixture is stirred at 35° C. for 2 h again to obtain the octadecyl acrylate emulsion.

(3) The octadecyl acrylate emulsion obtained from (2), α,α-diethoxy acetophenone (Shanghai Chemical Reagent Factory), methyl methacrylate (Shanghai Chemical Reagent Factory), and the fibers sieved in (1) are mixed at a weight ratio of 20:4:10:66, and milled at a constant temperature of 35° C. for 3 h to obtain the frame sealant.

FIG. 2A is a scanning electron microscope (SEM) of the frame sealant after being cured. It can be seen from FIG. 2A that the frame sealant is solidified to form pores with a micrometer size, and it can also be seen from FIG. 2A that the fiber (FIG. 2B is a local magnification of fiber 1) has been fully soaked by a hydrophobic octadecyl acrylate resin.

### Example 2

(1) Hemp fibers are pulverized by a fiber crusher (Qingdao Ruixintai Machinery Technology Co., Ltd) and the pulverized hemp fibers are sieved by a sieve with 1200 meshes.

(2) A certain amount of hexadecyl methacrylate (Shanghai Chemical Reagent Factory) is placed in a reactor, and then O3 and O9 are added sequentially, and a mixture is obtained by stirring at a constant temperature of 30° C. for 4 h, wherein a weight ratio of the hexadecyl methacrylate and O3 and O10 is 75:10:15. Then, the mixture is added to a certain amount of distilled water at a rate of 9 drops per min, in which a weight ratio of the mixture to the distilled water is 45:55. Finally, the mixture is stirred at 30° C. for 3 h again to obtain the hexadecyl methacrylate emulsion.

(3) The hexadecyl methacrylate emulsion obtained from (2), α-hydroxy alkylphenone (a photoinitiator, Shanghai Chemical Reagent Factory), methyl methacrylate (Shanghai Chemical Reagent Factory), and the fibers sieved from (1) are mixed at a weight ratio of 30:8:20:42, and milled at a constant temperature of 30° C. for 2 h to obtain the frame sealant.

### Example 3

(1) Cotton fibers are pulverized by a fiber crusher (Qingdao Ruixintai Machinery Technology Co., Ltd), and the pulverized cotton fibers are sieved by a sieve with 1500 meshes;

(2) A certain amount of octadecyl acrylate is placed in a reactor, and then O3 and O10 are added sequentially, and a mixture is obtained by stirring at a constant temperature of 40° C. for 2 h, wherein a weight ratio of the octadecyl acrylate and O3 and O10 is 85:8:7; then the mixture is added to a certain amount of distilled water at a rate of 9 drops per min, in which a weight ratio of the mixture to the distilled water is 55:45. Finally, the mixture is stirred at 35° C. for 2 h again to obtain the octadecyl acrylate emulsion;

(3) The octadecyl acrylate emulsion obtained from (2), α-amino alkyl phenone (Shanghai Chemical Reagent Factory), methyl methacrylate (Shanghai Chemical Reagent Factory), and the fibers sieved in (1) are mixed at a weight ratio of 25:6:19:50, and milled at a constant temperature of 35° C. for 2 h to obtain the frame sealant.

### Example 4

(1) Hemp fibers are pulverized by a fiber crusher (Qingdao Ruixintai Machinery Technology Co., Ltd) and the pulverized hemp fibers are sieved by a sieve with 1400 meshes.

(2) A certain amount of tetradecyl methacrylate (Shanghai Chemical Reagent Factory) is placed in a reactor, and then O9 is added, and a mixture is obtained by stirring at a constant temperature of 35° C. for 3 h, wherein a weight ratio of the tetradecyl methacrylate to O9 is 80:20. Then the mixture is added to a certain amount of distilled water at a rate of 8 drops per min, in which a weight ratio of the mixture to the distilled water is 47:53. Finally, the mixture is stirred at 30° C. for 2 h again to obtain the tetradecyl methacrylate emulsion.

(3) The tetradecyl methacrylate emulsion obtained from (2), α,α-diethoxy acetophenone, methyl methacrylate, and the fibers sieved in (1) are mixed at a weight ratio of 25:5:15:55, and milled at a constant temperature of 38° C. for 2 h to obtain the frame sealant.

### Example 5

(1) Hemp fibers are pulverized by a fiber crusher (Qingdao Ruixintai Machinery Technology Co., Ltd) and the pulverized hemp fibers are sieved by a sieve with 1300 meshes.

(2) A certain amount of urethane dimethacrylate (Shanghai Chemical Reagent Factory) is placed in a reactor, and then O3 is added, and a mixture is obtained by stirring at a constant temperature of 35° C. for 2 h, wherein a weight ratio of the urethane dimethacrylate to O3 is 75:25. Then, the mixture is added to a certain amount of distilled water at a rate of 8 drops per min, in which a weight ratio of the mixture to the distilled water is 52:48. Finally, the mixture is stirred at 35° C. for 2 h again to obtain the urethane dimethacrylate emulsion;

(3) The urethane dimethacrylate emulsion obtained from (2), α-amino alkyl phenone (Shanghai Chemical Reagent Factory), methyl methacrylate (Shanghai Chemical Reagent Factory), and the fibers sieved in (1) are mixed at a weight ratio of 25:5:15:55, and milled at a constant temperature of 40° C. for 2 h to obtain the frame sealant.

### Example 6

(1) The main frame sealant (SWB101, purchased from Sekisui Company, Japan) comprises: a low viscosity epoxy acrylic photo-curable resin, an epoxy resin, a photoinitiator, a heat curing agent, a coupling agent, an organic powder, an inorganic powder, and glass microspheres treated by safe gas (SI-040GH, purchased from Sekisui Company, Japan);

(2) The edge of the upper glass substrate is coated with the frame sealant of Example 1 by a spray nozzle with a diameter of 0.4 mm, and the frame sealant acts as the peripheral frame sealant 4. The main frame sealant 2 of (1) is applied around the interior display panel, and then is solidified.

(3) The upper glass substrate and the lower glass substrate are assembled to obtain the display mother substrate.

After testing, the breakage rate of the display mother substrate in Example 6 is 0.06%.

### Example 7

(1) The main frame sealant is the same as that in Example 6.

(2) The edges of the upper glass substrate and the lower glass substrate are coated with the frame sealant of Example 2 by a spray nozzle with a diameter of 0.4 mm, and the frame sealant acts as the peripheral frame sealant. The main frame sealant of (1) is applied around the interior display panel, and then is solidified.

(3) The upper glass substrate and the lower glass substrate are assembled to obtain the display mother substrate.

After testing, the breakage rate of the display mother substrate in Example 7 is 0.08%.

### Comparison Example

(1) The main frame sealant is the same as that in Example 6;

(2) The main frame sealant of (1) is applied around the interior display panel, and the edge of the upper glass substrate is coated with the main frame sealant of (1), and then the main frame sealant is solidified.

(3) The upper glass substrate and the lower glass substrate are assembled to obtain the display mother substrate.

After testing, the breakage rate of the display mother substrate in the comparison example is 21%.

In the embodiments of the present disclosure, the breakage rate of the display mother substrate (%) is determined by visually inspection and calculation of the number of damaged samples in the same batch of 10000 samples manufactured.

The frame sealant, its manufacturing method, the display mother substrate and the display device provided by the embodiments of the present disclosure have at least one of the following beneficial effects:

(1) the frame sealant has air permeability, and even if air is sealed inside the Q-panel, the sealed air can gradually disappear in a vacuum environment;

(2) the frame sealant can prevent acidic liquids from entering; and

(3) the frame sealant can avoid bursting caused by the air pressure inside the Q-panel in an open process.

Please Note that:

(1) the drawings of the embodiments of the present disclosure are only related to the structures mentioned in the embodiments of the present disclosure, and other structures can be further obtained by general designs;

(2) for the sake of clarity, in the drawings for describing the embodiments of the present disclosure, sizes of layers or regions are not drawn according to an actual scale but are exaggerated or diminished; it will be understood that when an element such as a layer, a film, a region or a substrate is referred to as being “on” or “under” another element, the element may be “directly” disposed “on” or “under” another element, or there may be an intermediate element; and

(3) the embodiments of the present disclosure and the features therein can be combined with each other to obtain new embodiments in the absence of conflicts.

What are described above is related to only the illustrative embodiments of the present disclosure and not limitative to the scope of protection of the present disclosure. The scope of protection of the present disclosure shall be defined by the accompanying claims.

1: A frame sealant, comprising:
about 20 to 30 parts by weight of a long-chain acrylate emulsion,
about 4 to 8 parts by weight of a photoinitiator,
about 10 to 20 parts by weight of a methacrylate, and
about 46 to 66 parts by weight of a fiber.

2: The frame sealant according to claim 1, comprising:
about 22 to 28 parts by weight of the long-chain acrylate emulsion,
about 5 to 7 parts by weight of the photoinitiator,
about 12 to 18 parts by weight of the methacrylate, and
about 48 to 60 parts by weight of the fiber.

3: The frame sealant according to claim 2, comprising:
about 25 parts by weight of the long-chain acrylate emulsion,
about 6 parts by weight of the photoinitiator,
about 15 parts by weight of the methacrylate, and
about 54 parts by weight of the fiber.

4: The frame sealant according to claim 1, wherein the fiber comprises at least one of a natural fiber, a glass fiber, a carbon fiber, a boron fiber, a metal fiber and a ceramic fiber.

5: The frame sealant according to claim 4, wherein the natural fiber comprises at least one of a cotton fiber and a hemp fiber.

6: The frame sealant according to claim 1, wherein the long-chain acrylate emulsion is a mixture formed by a long-chain acrylate, an emulsifier and deionized water.

7: The frame sealant according to claim 6, wherein a weight ratio of the long-chain acrylate, the emulsifier and the deionized water is about (41 to 46):about (8 to 18):about (41 to 46).

8: The frame sealant according to claim 7, wherein the weight ratio of the long-chain acrylate, the emulsifier and the deionized water is about (42 to 45):about (11 to 16):about (42 to 45).

9: The frame sealant according to claim 8, wherein the weight ratio of the long-chain acrylate, the emulsifier and the deionized water is about 44:12:44.

10: The frame sealant according to claim 6, wherein the long-chain acrylate comprises at least one of octadecyl acrylate, hexadecyl methacrylate, tetradecyl methacrylate, and urethane dimethacrylate.

11: The frame sealant according to claim 6, wherein the emulsifier comprises at least one of fatty alcohol polyoxyethylene ether (N=3), fatty alcohol polyoxyethylene ether (N=9) and fatty alcohol polyoxyethylene ether (N=10).

12: The frame sealant according to claim 1, wherein the photoinitiator comprises at least one of α,α-diethoxyacetophenone, α-hydroxyalkylphenone and α-amino alkyl phenone.

13: A manufacturing method of the frame sealant according to claim 1, comprising:
forming the long-chain acrylate emulsion; and
mixing and milling about 20 to 30 parts by weight of the long-chain acrylate emulsion, about 4 to 8 parts by weight of the photoinitiator, about 10 to 20 parts by weight of the methacrylate, and about 46 to 66 parts by weight of the fiber to obtain the frame sealant.

14: The manufacturing method according to claim 13, wherein the forming the long-chain acrylate emulsion comprises: placing a long-chain acrylate and an emulsifier in a reactor to form a mixture, stirring the mixture at a temperature of about 30° C. to about 45° C., adding deionized water to the mixture, and stirring the mixture again.

15: The manufacturing method according to claim 13, wherein a weight ratio of the long-chain acrylate, the emulsifier and the deionized water is about (41 to 46):about (8 to 18):about (41 to 46).

16: The manufacturing method according to claim 15, wherein the weight ratio of the long-chain acrylate, the emulsifier and the deionized water is about (42 to 45):about (11 to 16):about (42 to 45).

17: The manufacturing method according to claim 16, wherein the weight ratio of the long-chain acrylate, the emulsifier and the deionized water is about 44:12:44.

18: A display mother substrate, comprising: the frame sealant according to claim 1.

19: A display device, comprising: a display panel in the display mother substrate according to claim 18.

20: The frame sealant according to claim 7, wherein the long-chain acrylate comprises at least one of octadecyl acrylate, hexadecyl methacrylate, tetradecyl methacrylate, and urethane dimethacrylate.
